(19) United States
(12) Patent Application Publication
(10) Pub. No.: US 2016/0363311 A1
(43) Pub. Date: Dec. 15, 2016

(54) Piano and Electronic Keyboard Lighting Apparatus with Optional Music Rack Light

(71) Applicant: University of Alaska Fairbanks, Fairbanks, AK (US)

(72) Inventor: Gary Toth, Fairbanks, AK (US)

(21) Appl. No.: 14/581,537

(22) Filed: Dec. 23, 2014

(51) Int. Cl. F21V 33/00; F21V 23/04; G10C 3/00; F21S 9/02

(52) U.S. Cl. CPC F21V 33/0056; F21S 9/02; F21V 23/04; G10C 3/00

(57) ABSTRACT

This invention discloses a light assembly containing preferably an LED light strip that rests at either side of the piano keys and spans the entire keyboard. The assembly is controlled by an infinitely variable light dimmer mounted at either side of the keyboard powered directly from either a 110 v AC outlet or from a rechargeable battery built into the same casing that houses the dimmer. Optionally, the invention can comprise a music rack light, controllable by the user. This optional music rack light has its own infinitely variable light dimmer, which is housed in the same casing as the piano keyboard light dimmer assembly and operates off the same battery or power source. This invention enables a pianist to easily see the keys in any lighting situation without interfering with the pianist's ability to play the piano or keyboard.

### CROSS-REFERENCE TO RELATED APPLICATIONS

None.

STATEMENT REGARDING FEDERALLY SPONSORED RESEARCH OR DEVELOPMENT

This invention has not, as of the time of filing, been the subject of any federally sponsored research or development.

### STATEMENT REGARDING PRIOR DISCLOSURES BY AN INVENTOR OR JOINT INVENTOR

This invention was used in a piano concert open to the public on Feb. 14, 2014.

### FIELD OF THE INVENTION

This invention relates to a new apparatus for illuminating the keys of a piano or electronic keyboard, with the option of also illuminating music or other paperwork set upon a music rack attached to the piano or keyboard frame, by utilizing dimmer switches controllable by the user.

### BACKGROUND OF THE INVENTION

Pianos and keyboards are frequently used in live performances, which involve darkened rooms, concert halls, or stadiums, and require the player to struggle to see the keys as they are playing. Presently a musician wishing to perform a piece of music in a darkened space is either forced to commit the piece of music to memory or must rely on lights that perform poorly, as sight reading sheet music is likely out of the question in such dimly lit conditions. The performer also has to struggle to see the position of his or her hands if the player removes them from the keys at some point during the performance.

This invention would provide a performer with the light needed to not only see the keys of the piano or keyboard, but would also allow the audience to focus on the hands of the performer by turning the apparatus to its highest light setting. An additional embodiment of this invention would allow a user to illuminate sheet music or other papers placed on a music rack attached to the piano or keyboard frame, making sight reading of music possible even in dimly lit conditions.

### SUMMARY OF THE INVENTION

Disclosed herein is an apparatus which comprises a housing containing lamps held in the under-facing of the housing, which sits above the keys of a piano or electronic keyboard, with a dimmer/battery-pack assembly controlling the level of light emitted by the housing, and an optional music rack light with an adjustable goose-neck design with a separate dimmer/battery-pack controllable by the user to illuminate papers or sheet music placed on the music rack.

### BRIEF DESCRIPTION OF THE DRAWINGS

The accompanying drawings, which are incorporated in and constitute a part of this specification, illustrate an embodiment of the invention, and together with the description, serve to explain the principles of the invention.

FIG. 1 illustrates the housing containing lamps that sit above the keys of a piano or keyboard.

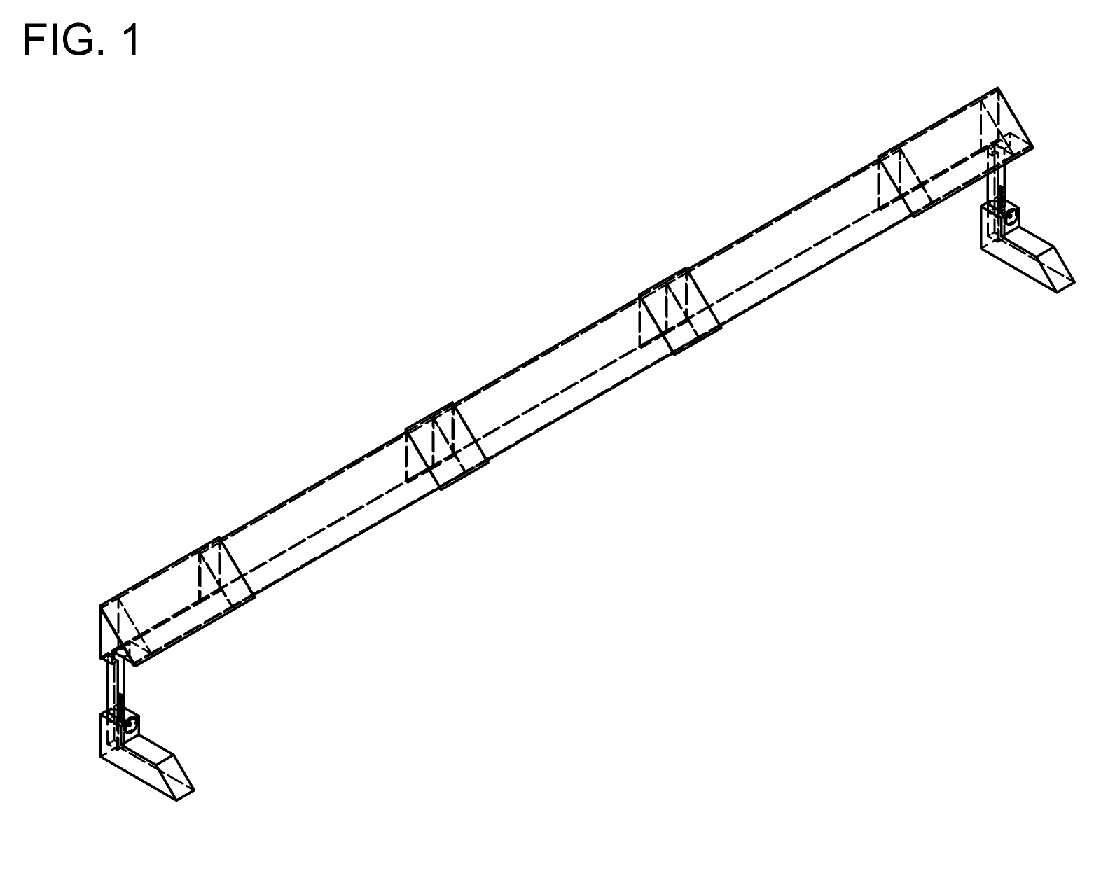

FIG. 2 illustrates the dimmer/battery-pack assembly that can sit at either end of the piano and the input and output connections for the power cable and connections to the keyboard and music rack lights.

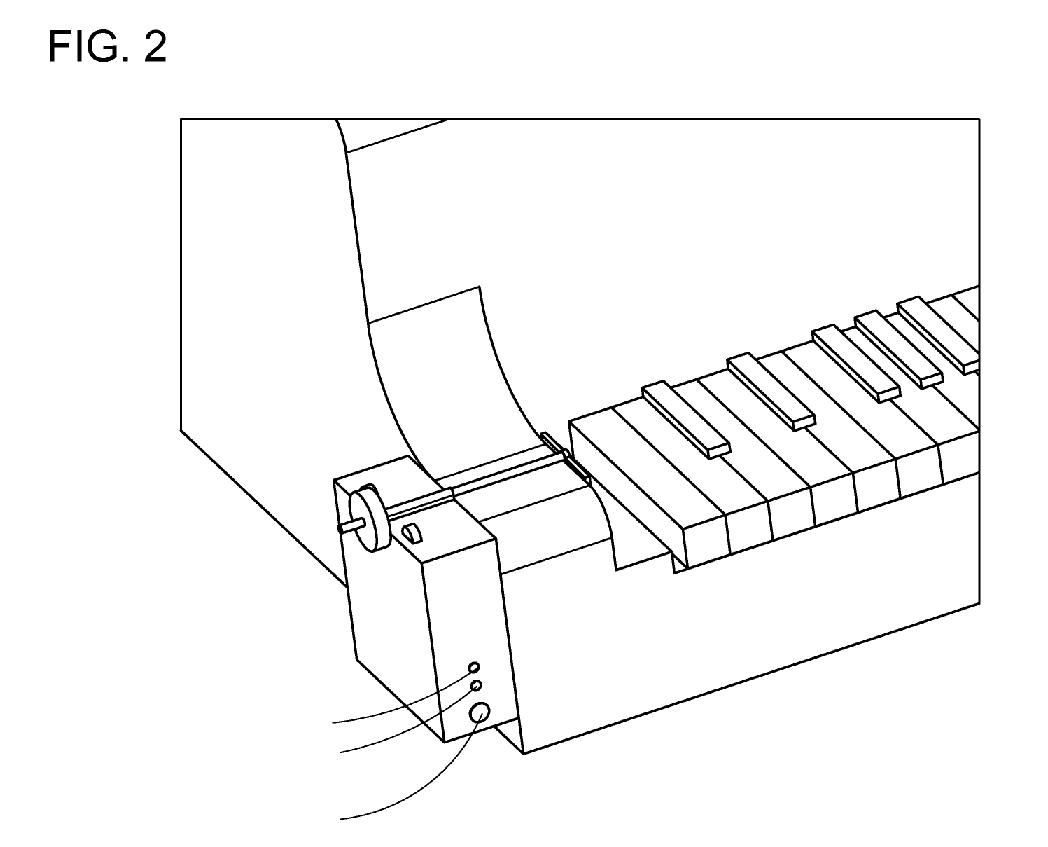

FIG. 3 illustrates a back view of the optional music rack lighting component showing bulbs running along the top of the rack to illuminate sheet music on the music rack, and showing a tension-adjusted height knob.

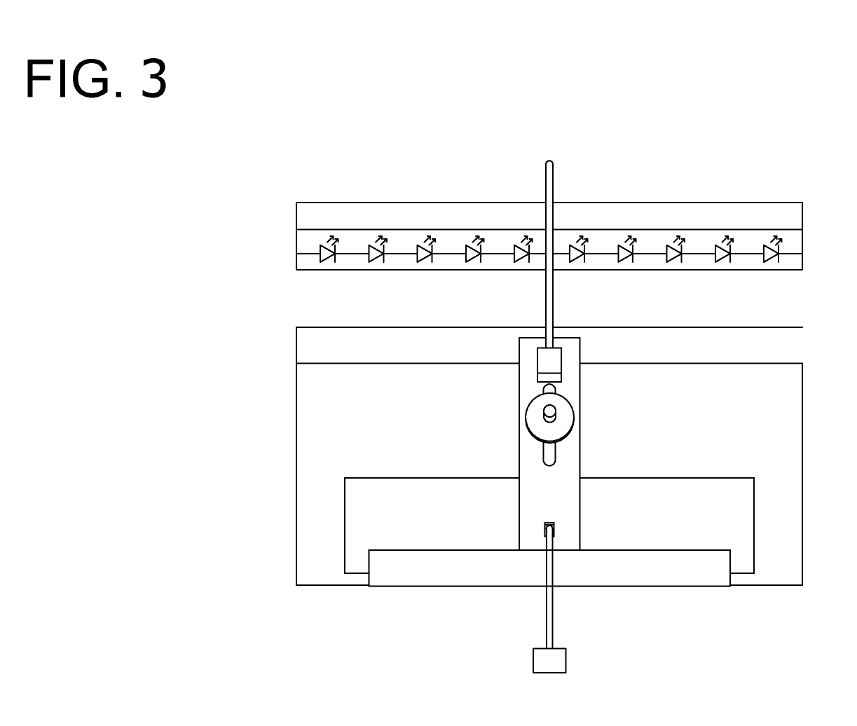

FIG. 4 illustrates a side view of the optional music rack lighting component, shown mounted to a piano music rack.

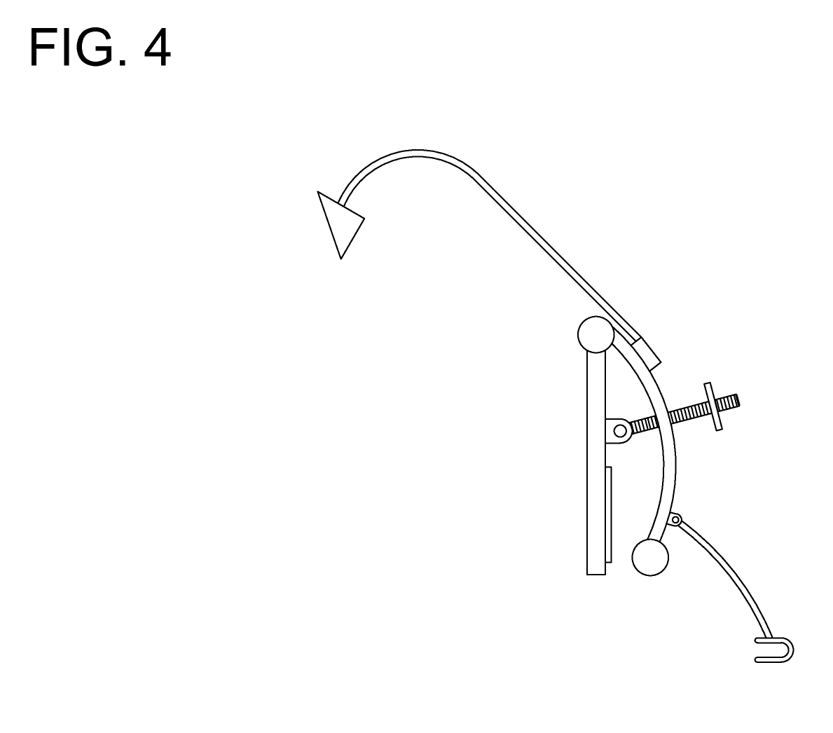

FIG. 5 shows the relationship between the dimmer/battery-pack assembly of FIG. 2 and the adjustable end support for the light hood of FIG. 1.

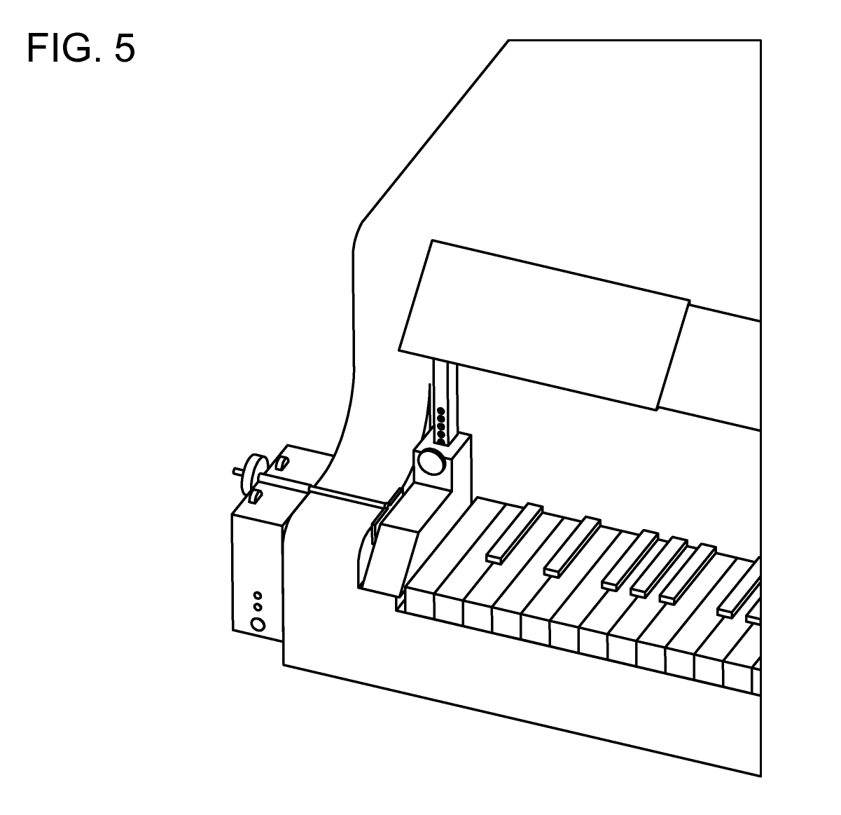

FIG. 6 illustrates the front view of the optional music rack lighting component, showing a goose-neck style lamp attached to the back of the music rack. The brightness of the light is controlled by a second dimmer in the dimmer assembly.

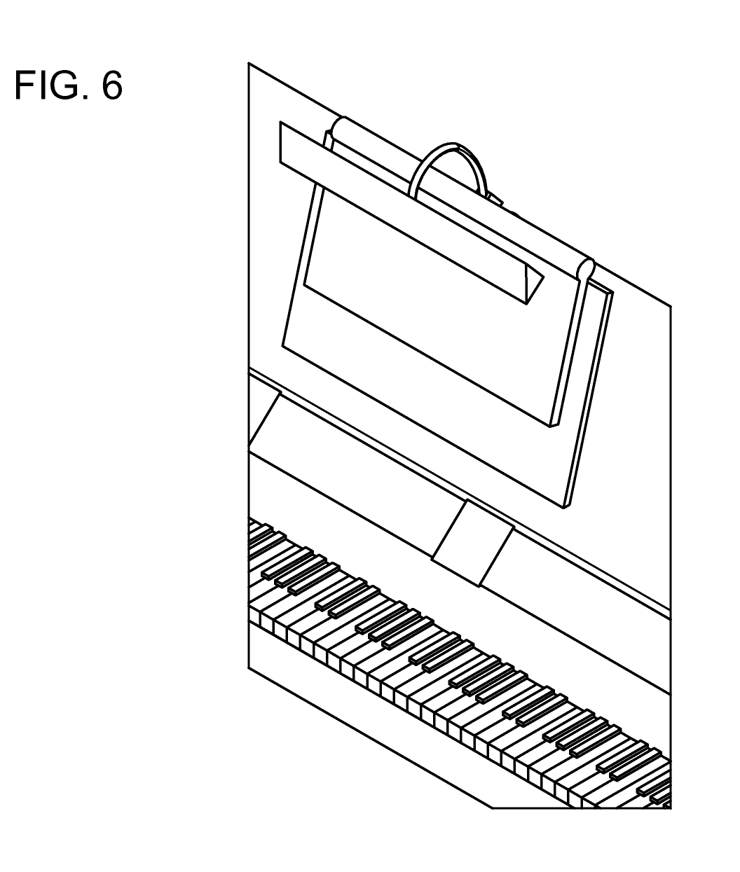

FIG. 7 illustrates a piano with a full installation of the piano keyboard lighting apparatus of FIG. 1, the dimmer/battery-pack assembly of FIG. 2 and optional music rack lighting component of FIGS. 4 and 6.

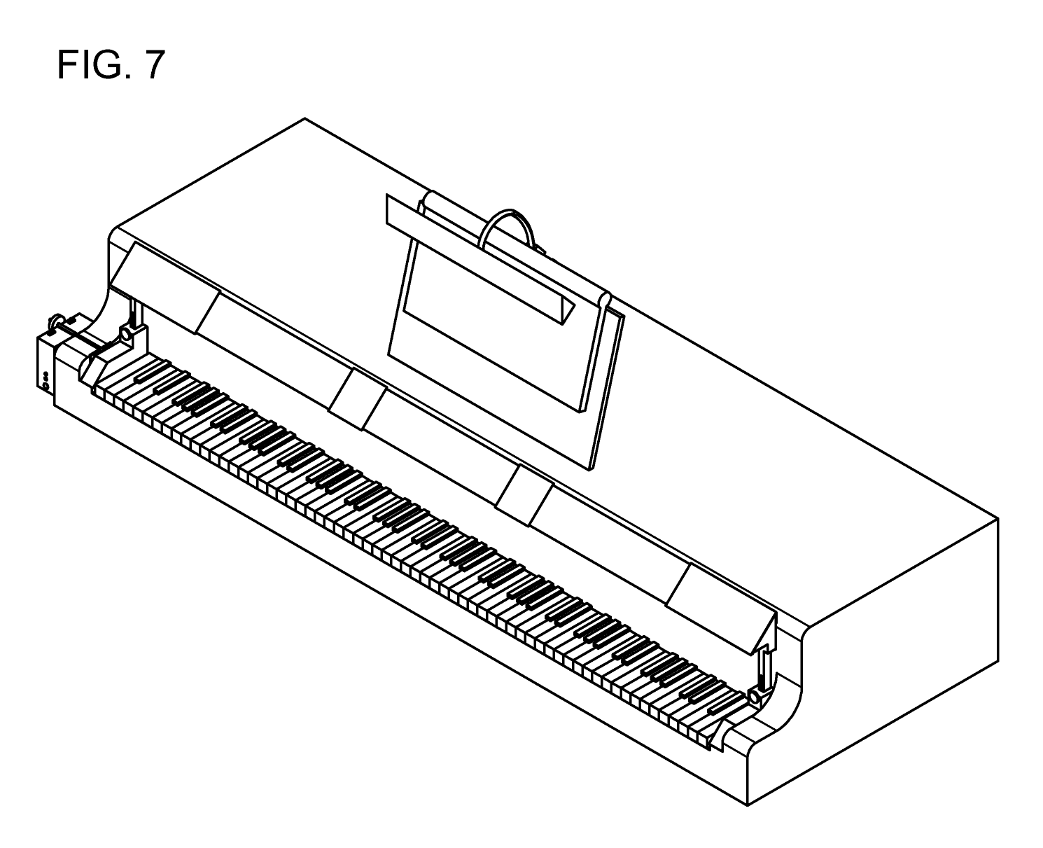

### DETAILED DESCRIPTION OF THE INVENTION

Before the present method is disclosed and described, it is to be understood that this invention is not limited to specific methods, specific components, or to particular compositions, as such may, of course, vary. It is also to be understood that the terminology used herein is for the purpose of describing particular embodiments only and is not intended to be limiting.

As used in the specification and the appended claims, the singular forms “a,” “an” and “the” include plural referents unless the context clearly dictates otherwise.

“Optional” or “optionally” means that the subsequently described event or circumstance may or may not occur, and that the description includes instances where said event or circumstance occurs and instances where it does not.

The present invention may be understood more readily by reference to the following detailed description of the preferred embodiment of the invention and the examples included therein and to the Figures and its previous and following description.

Disclosed herein is a lighting apparatus for the keys on a piano or keyboard, which includes a housing containing lamps that sit above the keys of a piano or keyboard, a dimmer/battery-pack assembly that can be located at either end of the piano or keyboard, and a power connector for the lights located in the dimmer assembly. The apparatus can optionally comprise a music rack light which can be manually controlled by the user independently from the piano keyboard light to illuminate sheet music or other paperwork needed for a performance.

1. A keyboard lighting apparatus for illuminating the keys of a piano or keyboard comprising:
a housing containing a band of lamps,
a dimmer assembly located at either end of the piano, and a
power source for the housed lamps.

2. The apparatus of claim 1, further comprising a housing that is suspended above the keys of the piano or keyboard.

3. The apparatus of claim 1, further comprising a 110V electrical outlet connection as the power source.

4. The apparatus of claim 1, further comprising rechargeable battery operated lamps as the power source.

5. The apparatus of claim 1, further comprising a gooseneck-style adjustable lamp attached to the music rack to illuminate sheet music or other paperwork placed upon a music rack on the piano or keyboard.

6. The apparatus of claim 5, further comprising a separate dimmer assembly located at either end of the piano that operates independently of the dimmer assembly in claim 1.

7. The separate dimmer assembly of claim 6, further comprising a 110V electrical outlet connection as the power source.

8. The separate dimmer assembly of claim 6, further comprising rechargeable battery operated lamps as the power source.

9. The separate dimmer assembly of claim 6, further comprising a shared power source with the apparatus of claim 1.
